(19) United States
(12) Patent Application Publication
(10) Pub. No.: US 2020/0346685 A1
(43) Pub. Date: Nov. 5, 2020

(54) STEERING DEVICE

(71) Applicant: Isuzu Motors Limited, Tokyo (JP)

(72) Inventors: Junpei OKUTANI, Fujisawa-shi (JP); Haruyuki HOSOYA, Yokohama-shi (JP); Kousuke KAWAKAMI, Yokohama-shi (JP)

(73) Assignee: Isuzu Motors Limited, Tokyo (JP)

(21) Appl. No.: 16/642,916

(22) PCT Filed: Jul. 18, 2018
(86) PCT No.: PCT/JP2018/026790

§ 371 Date: Feb. 28, 2020

(30) Foreign Application Priority Data
Aug. 30, 2017 (JP) 2017-165737

(51) Int. Cl. B62D 5/04

(52) U.S. Cl. CPC B62D 5/0415

(57) ABSTRACT

A steering device exhibiting improved layout properties around a steering shaft. A steering device (1) installed in a vehicle has a first steering shaft (4) connected to the steering wheel (3), and a coaxial motor (20) which applies a rotational force to the first steering shaft (4) and is provided in a manner such that the output shaft thereof is coaxial with the first steering shaft (4).

### TECHNICAL FIELD

The present disclosure relates to a steering device mounted on a vehicle.

### BACKGROUND ART

Conventionally, it is known that, regarding steering devices to be mounted on a vehicle, some of the steering devices include, in a vehicle cabin, a motor for applying a rotational force to a steering shaft (see, for example, Patent Literature (hereinafter, referred to as “PTL”) 1).

Some of such steering devices include a motor with an output shaft disposed so as to be orthogonal or substantially orthogonal to the steering shaft, and convert the direction of the rotational force of the motor into the rotational direction of the steering shaft by a worm wheel mechanism.

### CITATION LIST

### Patent Literature

### PTL 1

Japanese Patent Application Laid-Open No. 2007-112240

### SUMMARY OF INVENTION

### Technical Problem

However, because the motor needs to be arranged so as not to interfere with various devices (for example, a parking brake, a switch panel, and the like) disposed around the steering shaft in the conventional steering devices described above, the conventional steering devices have room for improvement in terms of the layout quality around the steering shaft.

An object of the present disclosure is to provide a steering device which makes it possible to improve the layout quality around a steering shaft.

### Solution to Problem

The steering device according to one aspect of the present disclosure is a steering device to be mounted on a vehicle, the steering device including: a steering shaft connected to a steering wheel; and a coaxial motor including an output shaft arranged coaxially with the steering shaft, the coaxial motor applying a rotational force to the steering shaft, in which the coaxial motor is provided on a portion of the steering shaft, the portion being located below the steering wheel and above a floor of a vehicle cabin.

### Advantageous Effects of Invention

According to the present disclosure, it is possible to improve the layout quality around the steering shaft.

### BRIEF DESCRIPTION OF DRAWINGS

FIG. 1 schematically illustrates one example of a steering device according to an embodiment of the present disclosure; and

FIG. 2 schematically illustrates one example of a steering device according to a modification of the present disclosure.

### DESCRIPTION OF EMBODIMENT

Hereinafter, an embodiment of the present disclosure will be described in detail with reference to the accompanying drawings.

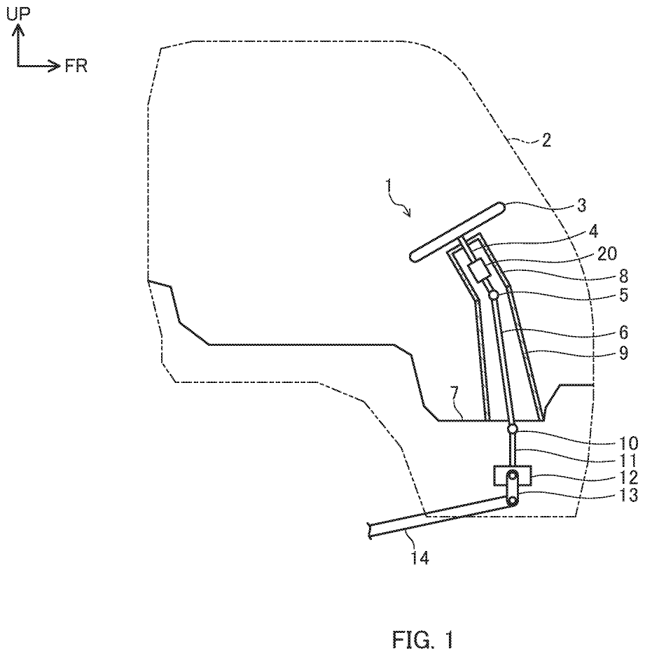

Steering device 1 according to the present embodiment will be described with reference to FIG. 1. FIG. 1 schematically illustrates steering device 1 according to the present embodiment. In FIG. 1, FR indicates the front side of a vehicle, and UP indicates the upper side of the vehicle.

Steering device 1 is mounted on the vehicle provided with vehicle cabin 2. The vehicle is a cab-over type vehicle (for example, a truck, a bus, a van, or the like) provided with vehicle cabin 2 above an internal combustion engine (not illustrated).

Steering device 1 includes steering wheel 3, first steering shaft 4, first joint part 5, second steering shaft 6, second joint part 10, third steering shaft 11, power steering unit 12, pitman arm 13, drag link 14, and coaxial motor 20.

Steering wheel 3 is a device with which a driver performs a rotating operation for steering the vehicle.

First steering shaft 4 is a rotatable rod-like member, and is connected at one end to steering wheel 3 and connected at the other end to first joint part 5.

First joint part 5 couples first steering shaft 4 to second steering shaft 6 at a predetermined angle.

First steering shaft 4 is covered peripherally by a cylindrical upper cover (also referred to as a steering cowl) 8. Meanwhile, first joint part 5 is covered peripherally by a cylindrical lower cover (also referred to as a column cover or a column boot) 9. The upper end of lower cover 9 is connected to the lower end of upper cover 8, and the lower end of lower cover 9 is fixed to floor (bottom) 7 of vehicle cabin 2.

Second steering shaft 6 is a rotatable rod-like member, and includes a shaft (not illustrated) and a cylindrical member (not illustrated) surrounding the shaft, which are coupled together so as to be relatively slidable in the axial direction, making second steering shaft 6 extendible and retractable, for example.

Second steering shaft 6 is connected at one end to first joint part 5 and connected at the other end to second joint part 10 disposed below floor 7 (outside vehicle cabin 2). Specifically, the other end of second steering shaft 6 is inserted into an opening (not illustrated) formed in floor 7 and connected to second joint part 10.

Second joint part 10 couples second steering shaft 6 to third steering shaft 11 at a predetermined angle.

A portion of second steering shaft 6 located above floor 7 (portion located in vehicle cabin 2) is covered peripherally by lower cover 9.

Third steering shaft 11 is a rotatable rod-like member, and is connected at one end to second joint part 10 and connected at the other end to power steering unit (also referred to as steering gearbox) 12.

The rotational force of steering wheel 3 is transmitted to power steering unit 12 via first steering shaft 4, second steering shaft 6, and third steering shaft 11.

Power steering unit 12 converts the rotational force transmitted as described above into a larger force that swings pitman arm 13. Thus, pitman arm 13 swings to push or pull drag link 14, so that wheels (not illustrated) are steered via knuckle arms and tie rods (both not illustrated).

Here, a description will be given of a characteristic configuration of the present embodiment.

In the present embodiment, coaxial motor 20 is attached to first steering shaft 4 as shown in FIG. 1. Coaxial motor 20 is housed in upper cover 8.

An output shaft (not illustrated) of coaxial motor 20 is arranged coaxially with first steering shaft 4. Coaxial motor 20 is driven under the control of an ECU (not illustrated) to apply the rotational force to first steering shaft 4.

For example, when a driving assistance function is executed, the ECU drives coaxial motor 20 such that a predetermined level of rotational force is applied to first steering shaft 4 at a predetermined timing. Examples of the driving assistance function include automatic parking, lane keeping assist during cruise control, and the like.

The rotational force of first steering shaft 4 caused by driving of coaxial motor 20 is transmitted to power steering unit 12 via second steering shaft 6 and third steering shaft 11.

As described above, steering device 1 according to the present embodiment is characterized in that first steering shaft 4 is provided with coaxial motor 20. Since coaxial motor 20 can be disposed without interfering with various devices (for example, a parking brake, a switch panel, and the like) provided around the steering shaft, steering device 1 of the present embodiment allows improvement in layout quality around the steering shaft.

The present disclosure is not limited to the above-described embodiments, and can be appropriately modified and implemented without departing from the spirit of the present disclosure. Hereinafter, each modification will be described.

[Modification 1]

Although the embodiment has been described in relation to the case where first steering shaft 4 is provided with coaxial motor 20, the present disclosure is not limited to this example. For example, coaxial motor 20 may be provided on a portion of second steering shaft 6 which is located above floor 7 (in other words, a portion inside vehicle cabin 2).

That is, coaxial motor 20 only have to be provided on a portion of first steering shaft 4 or second steering shaft 6 which is located below steering wheel 3 and above floor 7.

[Modification 2]

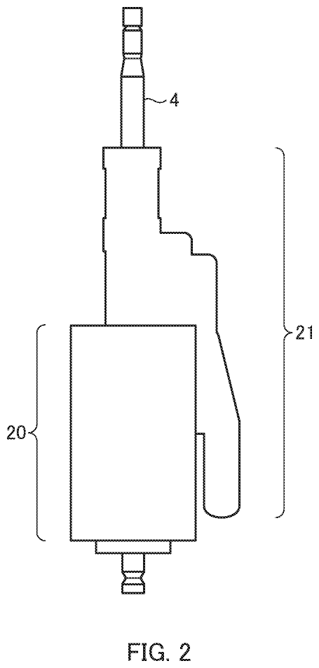

As shown, for example, in FIG. 2, coaxial motor 20 may also be provided below shaft bracket 21 that supports first steering shaft 4 such that first steering shaft 4 is rotatable. Shaft bracket 21 is provided between steering wheel 3 and first joint part 5, for example.

[Modification 3]

Steering device 1 only have to include, as its minimum configuration, coaxial motor 20 and a steering shaft (first steering shaft 4 or second steering shaft 6) to which coaxial motor 20 is attached.

[Modification 4]

Although the embodiment has been described in relation to the case where the vehicle on which steering device 1 is mounted is the cab-over type vehicle, the present disclosure is not limited to this example. Steering device 1 may also be mounted on a vehicle provided with an internal combustion engine in front of or behind vehicle cabin 2.

### SUMMARY OF DISCLOSURE

The steering device according to the present disclosure is a steering device to be mounted on a vehicle, the steering device including the steering shaft connected to the steering wheel, and the coaxial motor including an output shaft arranged coaxially with the steering shaft, the coaxial motor applying the rotational force to the steering shaft, in which the coaxial motor is provided on a portion of the steering shaft which is located below the steering wheel and above the floor of the vehicle cabin.

In the steering device described above, the coaxial motor may be provided below the shaft bracket that supports the steering shaft such that the steering shaft is rotatable.

### INDUSTRIAL APPLICABILITY

This application is based on Japanese Patent Application No. 2017-165737, filed on Aug. 30, 2017, the disclosure of which is incorporated herein by reference in its entirety.

The steering device of the present disclosure is applicable to a steering device of a vehicle.

### REFERENCE SIGNS LIST

1 Steering device
2 Vehicle cabin
3 Steering wheel
4 First steering shaft
5 First joint part
6 Second steering shaft
7 Floor
8 Upper cover
9 Lower cover
10 Second joint part
11 Third steering shaft
12 Power steering unit
13 Pitman arm
14 Drag link
20 Coaxial motor
21 Shaft bracket

What is claimed is:

1. A steering device to be mounted on a vehicle, the steering device comprising:
a steering shaft connected to a steering wheel; and
a coaxial motor including an output shaft arranged coaxially with the steering shaft, the coaxial motor applying a rotational force to the steering shaft, wherein
the coaxial motor is provided on a portion of the steering shaft, the portion being located below the steering wheel and above the floor of a vehicle cabin.

2. The steering device according to claim 1, wherein the coaxial motor is provided below a shaft bracket, the shaft bracket supporting the steering shaft such that the steering shaft is rotatable.
